(19) United States
(12) Patent Application Publication
(10) Pub. No.: US 2024/0128435 A1
(43) Pub. Date: Apr. 18, 2024

(54) Carbon and Metal Oxide Composite Cathode for Batteries

(71) Applicants: Board of Trustees of Western Michigan University, Kalamazoo, MI (US); XBM USA LLC, Sheridan, WY (US)

(72) Inventors: Qingliu Wu, Portage, MI (US); Eduardo Javier Munoz, Long Beach, CA (US)

(21) Appl. No.: 18/486,127

(22) Filed: Oct. 12, 2023

Related U.S. Application Data
(60) Provisional application No. 63/415,447, filed on Oct. 12, 2022.

(51) Int. Cl. H01M 4/133; H01M 4/1393; H01M 10/052

(52) U.S. Cl. CPC H01M 4/133; H01M 4/1393; H01M 10/052; H01M 2004/028

(57) ABSTRACT

A cathode material for a lithium-sulfur battery is disclosed. The cathode material includes an active material comprising a host. The host includes resorcinol-formaldehyde carbon (RFC) and one or both of a metal and metal oxide. Elemental sulfur is coupled to the host. The cathode material may further include a conductive material (e.g., carbon) and a binder material.

### CROSS REFERENCE TO RELATED APPLICATIONS

The present application claims the benefit under 35 USC § 119(e) to U.S. Provisional Patent Application No. 63/415,447, filed Oct. 12, 2022; the entire disclosure of that application is incorporated herein by reference.

### TECHNOLOGICAL FIELD

The disclosure relates to a cathode for a lithium-sulfur battery and, more particularly, to a carbon and metal oxide composite cathode for a lithium-sulfur battery.

### BACKGROUND

Lithium-sulfur batteries (LSBs) are candidates for high-energy-density rechargeable battery systems. However, known LSBs may not maintain stable electrochemical performance and may experience fading of capacity with electrochemical cycling. During charge and discharge processes (e.g., cycling) polysulfides, which are an intermediate product of such, may dissolve and diffuse away from the sulfur cathode, toward the anode. At the anode, the polysulfides may be reduced to short-chain polysulfides and after diffusing back to the cathode long-chain polysulfides may be formed again. This “shuttle” effect may result in leakage of active material from the cathode and may cause degradation (e.g., a reduction in an energy density and rechargeability of LSB cells).

### SUMMARY

According to an aspect of the present disclosure, a lithium-sulfur battery cell includes an anode adjacent a first current collector. The anode comprises lithium metal. A cathode is coupled to a second current collector. The cathode includes an active material. The active material includes a host, which includes resorcinol-formaldehyde carbon (RFC) and one of a metal and metal oxide. Elemental sulfur is coupled to the host, a conductive additive, and a binder material. A separator is disposed between the anode and the cathode. An electrolyte is dispersed between the anode and the cathode.

According to another aspect of the present disclosure, a cathode material for a lithium-sulfur battery cell includes an active material that includes a host. The host includes resorcinol-formaldehyde carbon (RFC) and one of a metal and metal oxide. Elemental sulfur is coupled to the host. The cathode material also includes a conductive carbon material, and a binder material.

According to yet another aspect of the present disclosure, a method for preparing a cathode active material for a lithium-sulfur battery cell includes the steps of preparing a solution of a metal precursor and resorcinol-formaldehyde carbon (RFC). The method includes performing a first thermal treatment on the solution of the metal precursor and RFC, and then obtaining a host material. The host material includes a powder composite RFC decorated with one or more metal oxides. Then, the method includes impregnating the host material with elemental sulfur to synthesize the cathode active material.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a schematic, exploded view of an exemplary battery, according to various aspects described herein;

FIG. 2 is a schematic flow chart showing preparation of a metal, carbon and sulfur composite, according to various aspects described herein;

FIG. 3A is a graph showing X-ray diffraction spectra of various carbon and metal or carbon and metal oxide composites, according to various aspects described herein;

FIG. 3B is a graph showing X-ray diffraction spectra of various carbon and metal or carbon and metal oxide composites, according to various aspects described herein;

FIG. 3C is a graph showing X-ray diffraction spectra of various carbon and metal or carbon and metal oxide composites, according to various aspects described herein;

FIG. 3D is a graph showing X-ray diffraction spectra of various carbon and metal or carbon and metal oxide composites, according to various aspects described herein;

FIG. 4A is a graph showing thermogravimetric analysis (TGA) spectra of various cathode active material hosts impregnated with sulfur;

FIG. 4B is a graph showing thermogravimetric analysis (TGA) spectra of various cathode active material hosts impregnated with sulfur;

FIG. 4C is a graph showing thermogravimetric analysis (TGA) spectra of various cathode active material hosts impregnated with sulfur;

FIG. 4D is a graph showing thermogravimetric analysis (TGA) spectra of various cathode active material hosts impregnated with sulfur;

FIG. 5A is a graph showing galvanostatic charge-discharge profiles for a selected formation cycle of various lithium-sulfur battery cells;

FIG. 5B is a graph showing galvanostatic charge-discharge profiles for a selected formation cycle of various lithium-sulfur battery cells;

FIG. 6A is a graph showing galvanostatic charge-discharge profiles for a selected formation cycle of various lithium-sulfur battery cells;

FIG. 6B is a graph showing galvanostatic charge-discharge profiles for a selected formation cycle of various lithium-sulfur battery cells;

FIG. 7A is a graph showing galvanostatic charge-discharge profiles for a selected formation cycle of various lithium-sulfur battery cells;

FIG. 7B is a graph showing galvanostatic charge-discharge profiles for a selected formation cycle of various lithium-sulfur battery cells;

FIG. 8A is a graph showing galvanostatic charge-discharge profiles for a selected formation cycle of various lithium-sulfur battery cells;

FIG. 8B is a graph showing galvanostatic charge-discharge profiles for a selected formation cycle of various lithium-sulfur battery cells;

FIG. 9A is a graph showing galvanostatic charge-discharge profiles for a selected formation cycle of various lithium-sulfur battery cells;

FIG. 9B is a graph showing galvanostatic charge-discharge profiles for a selected formation cycle of various lithium-sulfur battery cells;

FIG. 10A is a graph showing cycling performance of a lithium-sulfur battery having a cathode with various carbon and metal oxide hosts; and

FIG. 10B is a graph showing cycling performance of a lithium-sulfur battery having a cathode with various carbon and metal hosts.

### DETAILED DESCRIPTION OF EMBODIMENTS

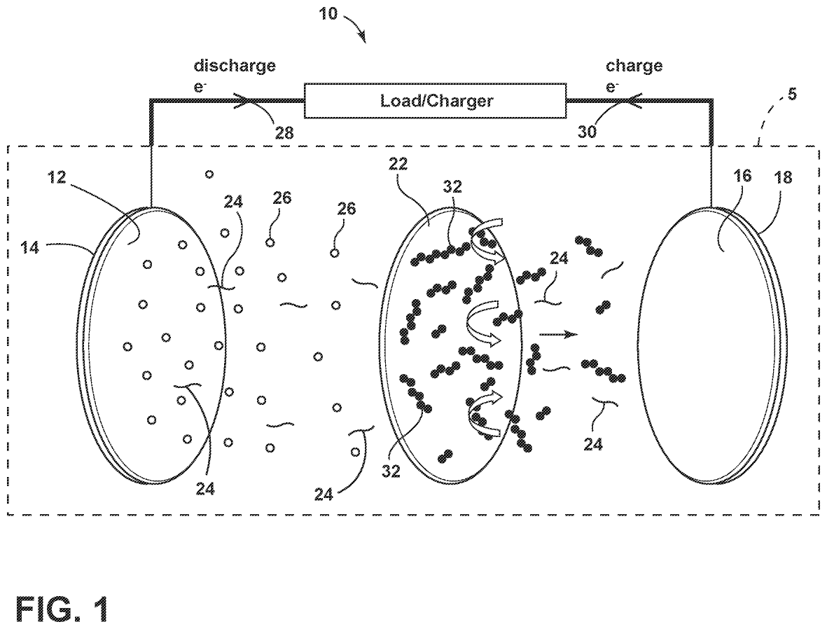

For purposes of description herein the terms “upper,” “lower,” “right,” “left,” “rear,” “front,” “vertical,” “horizontal,” and derivatives thereof shall relate to the device/disclosure as oriented in FIG. 1. However, it is to be understood that the device/invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

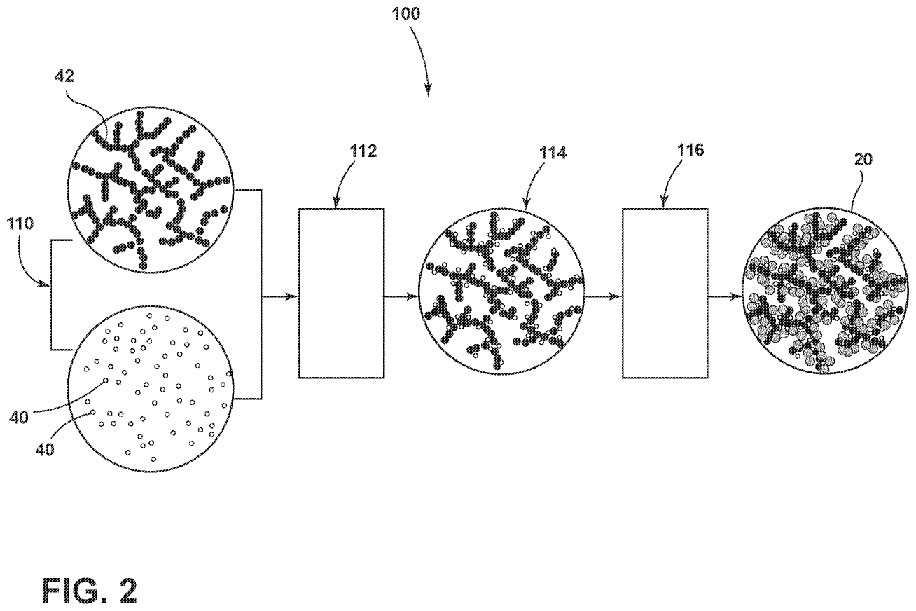

Referring to FIGS. 1-2, reference numeral 10 generally designates a lithium-sulfur battery (LSB) cell. The LSB cell 10 includes an anode 12 adjacent a first current collector 14. The anode 12 includes lithium metal. A cathode 16 is coupled to a second current collector 18. The cathode 16 includes an active material 20, a conductive additive, and a binder material. The active material 20 (FIG. 2) comprises a sulfur infiltrated host material. The host material may comprise resorcinol-formaldehyde carbon (RFC) and one or both of a metal and a metal oxide. Elemental sulfur (e.g., S₈) is coupled to the host. As discussed in more detail below, cathode 16 may be fabricated by mixing the active material in powder form with carbon black and a binder solution to form a slurry, and a metal substrate may then be coated with the slurry. The slurry is then dried to form a cathode 16 which may comprise about 80% by weight active material, 5% by weight conductive carbon, and 15% by weight binder. It will be understood that the present disclosure is not limited to those weight percentages, and the cathode 16 may have virtually any suitable weight % of the individual materials. As illustrated, a separator 22 is disposed between the anode 12 and the cathode 16. An electrolyte 24 is dispersed between the anode 12 and the cathode 16 in container or case 5. It will be understood that anode 12, cathode 16, and separator 22 may be positioned in parallel planes.

Referring to FIG. 1, chemical processes in the LSB cell 10 include lithium dissolution from the anode 12 during a discharge process 28 and reverse lithium plating to the anode 12 during a charge process 30. In the LSB 10, energy may be stored in the cathode 16. During the discharge process 28, lithium ions 26 in the electrolyte 24 migrate to the cathode 16 where the S₈ is reduced to lithium sulfide (Li₂S). The sulfur in Li₂S is re-oxidized to S₈ during the charge process 30. Although some aspects of the disclosure are described in connection with lithium-sulfur battery cell 10, it is within the scope of the disclosure for the cathode 16 to be used within any suitable electrochemical cell.

The first current collector 14, the second current collector 18, the separator 22, and the electrolyte 24 may be made of any suitable material for use in the LSB 10, which function in conjunction with the cathode 16 of the present disclosure. In some examples, the first current collector 14 may include stainless steel while the second current collector 18 may include aluminum, such as Al foil. However, it will be understood that the current collectors are not limited to these examples. The separator 22 may comprise polyolefin membrane (e.g., CELGARD® 2325), but the separator may comprise other suitable materials and the present disclosure is not limited to a specific material. Electrolyte 24 may comprise, for example, a solution of 1M lithium bis(trifluoromethane)sulfonimide (LiTFSI) and 2 wt. % LiNO₃ in DOL/DME (1/1, v/v). However, electrolyte 24 may comprise any suitable composition and in any suitable phase (e.g., liquid, solid).

In some examples, the cathode 16 includes approximately 80 weight % of the cathode active material 20, approximately 5 weight % of the conductive additive and approximately 15 weight % of the binder material. The conductive additive and the binder material may be any material suitable for use in conjunction with the cathode active material 20 of the present disclosure. In specific examples, the conductive additive is a conductive carbon (e.g., carbon black) and the binder material is a solution containing polyvinylidene fluoride (PVDF). A porous carbon is embedded with metal and/or metal oxides and is the host for the cathode active material 20 of the cathode 16 for the LSB cell 10.

In specific examples, resorcinol-formaldehyde carbon (RFC) powder is used, which is an advanced porous carbon that may provide controllable pore volume and pore size (e.g., by CO₂ activation). Porous carbon spheres may be prepared by direct carbonization of potassium salt of resorcinol-formaldehyde resin spheres, and CO₂ absorbents. These prepared carbon materials may maintain the spherical shapes after activation, and may also have highly developed ultra-microporosity with uniform pore size. The porous properties such as pore volume (i.e. the empty space (cm³/g) due to pores) and ratio may be controlled by tuning the process parameters as required for Li—S battery applications. It will be understood that there is a pore size distribution of the RFC and the contribution from different pores to the total volume (empty space) is different (not equal). For example, RFC may have an empty space of 100 cm³/g, and the pore size may be distributed from 2 nm to 100 nm. The empty space generated by pores with a diameter of <5 nm is 30 cm³/g, and 70 cm³/g is generated from >5 nm pores. The ratio should be 30 cm³/g/70 cm³/g=3/7.

Factors that can affect the properties, such as pore volume, size, and uniformity of RFC, include, for example, precursor concentrations, catalyst type and concentration, time and temperature of thermal treatment, and the method of drying. In some examples, NiSO₄, Mn(NO₃)₂, FeCl₃, La(NO₃)₃, Zr(NO₃)₄, and Mo(NO₃)₃ can be metal precursors 40 (FIG. 2) used for the host material. Accordingly, the one (or both) of the metal and metal oxide coupled to, or embedded in, the porous carbon can include any one or more of Ni, Mn, Fe, La, Zr, and Mo.

Referring to FIG. 2, a diagram of an exemplary method 100 of preparing a metal, carbon and sulfur composite for use as the cathode active material 20 is illustrated. The method 100 may begin at step 110, which involves preparing a solution of a metal precursor 40 and resorcinol-formaldehyde carbon (RFC) 42. Next, thermal treatment of the solution (metal precursor 40 and RFC 42) occurs at step 112. Step 112 is followed by step 114, which includes cooling the material resulting from the thermal treatment, and then obtaining the host material, which is a composite RFC decorated with one or more metal oxides. The host material obtained at step 114 may be in the form of a powder. Next, at step 116, the host material is impregnated with sulfur to synthesize the cathode active material 20. In some examples, step 116 is conducted using a melt-diffusion process. The melt diffusion process may include mixing elemental sulfur powders and the composite RFC decorated with one or more metal oxides, grinding the mixture, and then transferring the mixture to a sealed vessel. The vessel may then be heated to a target temperature of approximately 155° C. and held at the target temperature for approximately 12 hours to complete synthesis of the cathode active material 20.

Optionally, at step 112, the method 100 may include a first thermal treatment and a second thermal treatment of the metal precursor 40. A metal oxide decorated RFC (RFC@MO) may be synthesized after the first thermal treatment, and a metal decorated RFC (RFC@M) may be synthesized after the second thermal treatment. The first thermal treatment may be conducted in a tube furnace under the protection of Argon gas. Further, the first thermal treatment may utilize a target temperature of approximately 500° C. with a ramp rate of approximately 10° C./min. Once at the target temperature of approximately 500° C., the solution of metal precursor 40 and resorcinol-formaldehyde carbon (RFC) 42 may be kept at the target temperature for approximately two hours followed by cooling to obtain the RFC@MO. The second thermal treatment may be conducted in a tube furnace under the protection of a mixture of approximately 98% Argon and 2% H₂ gas. The second thermal treatment may utilize a target temperature of approximately 900° C. with a ramp rate of approximately 10° C./min. Once at the target temperature of approximately 900° C., the RFC@MO can be kept at the target temperature for approximately four (4) hours followed by cooling to obtain the RFC@M. The target temperature(s) and duration(s) may be varied depending on the desired amount of reduction of metal oxide to metal. For example, the first thermal treatment results in partial reduction to metal oxide, while the second thermal treatment results in full reduction to metal.

### EXAMPLES

### Example 1, Host Material Preparation

An approach involving the deposition of the metal precursor 40 followed by a two-step thermal treatment was employed to prepare metal (M) decorated resorcinol-formaldehyde derived porous carbon (RFC).

Metal oxide decorated RFC (RFC@MO): RFC@MO samples were synthesized first. Typically, 0.5 g RFC powders were dispersed in 20 mL DI-water and then a solution containing 5 mg metal precursor dissolved in 10 mL DI water was slowly added under continuous stirring. After the addition of the metal precursor solution, the mixture was stirred at room temperature for about six (6) hours and then dried at about 110° C. overnight. The feed rate of the metal precursor solution was carefully adjusted in the range of 0.1-5 mL/min in order to have the metal precursor uniformly distributed at the surface of RFC powders. The dried powders were placed in a crucible for the thermal treatment at high temperatures. The thermal treatment was conducted in a tube furnace under the protection of Argon gas. The tube furnace was heated to the target temperature of 500° C. with the ramp of 10° C./min and kept at the targeted temperature for two (2) hours. After cooled down to room temperature, RFC@MO powders were obtained. Different metal precursors, such as NiSO₄, Mn(NO₃)₂, FeCl₃, La(NO₃)₃, Zr(NO₃)₄, and Mo(NO₃)₃, were used to prepare RFC decorated with various metal oxides.

Metal decorated RFC (RFC@M): The same thermal treatment was applied to the obtained RFC@MO powders to fabricate RFC@M. Typically, the targeted temperature and duration time for the secondary thermal treatment were 900° C. and four (4) hours, respectively. A mixture of Argon with 2% H₂ was used as the protection gas. The targeted temperature and duration time were adjusted for full or partial reduction of metal oxide to metal.

### Example 2, Characterizations of Host Material Crystal Phase

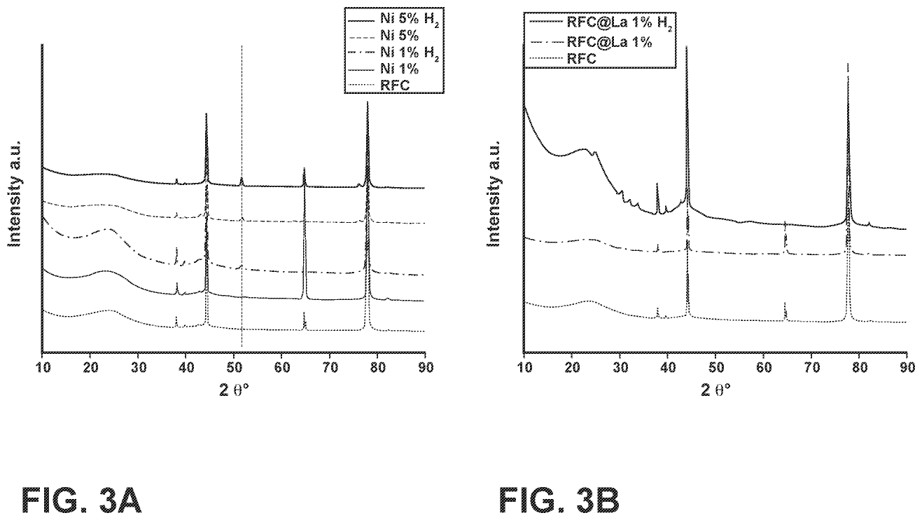

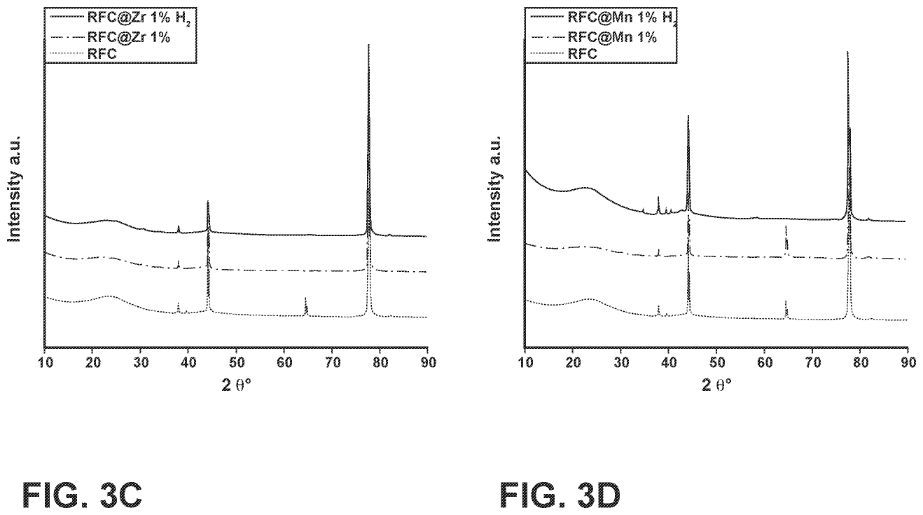

Referring to FIGS. 3A-3D, X-ray diffraction (XRD) patterns were collected on a Rigaku SmartLab diffractometer using a Cu Kα radiation (λ=1.54 Å) to reveal the crystal structures of the synthesized RFC@MO and RFC@M. The Segal and Scherrer equations were used to calculate the crystallinity index and crystallinity dimensions of different planes of MO and M, respectively.

FIG. 3A shows X-ray diffraction spectra of RFC@Ni(1%)O, RFC@Ni(1%), RFC@Ni(5%)O and RFC@Ni(5%) synthesized according to Example 1 along with a comparative RFC. As illustrated, metal and metal oxide peaks corresponding to nickel are present. The host materials in this example comprise greater than about 95% RFC and less than about <5% metal oxide or metal. Thus, the peaks from RFC have strong intensity, and these peaks should be present in XRD patters obtained from all samples. The presence of additional peaks confirms the existence of metal oxide or metal in the host materials. However, the intensity of these peaks is relatively weak due to the low amount of these materials in the samples.

FIG. 3B shows X-ray diffraction spectra of RFC@La(1%)O and RFC@La(1%) synthesized according to Example 1 along with a comparative RFC. As illustrated, metal and metal oxide peaks corresponding to lanthanum are present.

FIG. 3C shows X-ray diffraction spectra of RFC@Zr(1%)O and RFC@Zr(1%) synthesized according to Example 1 along with a comparative RFC. As illustrated, metal and metal oxide peaks corresponding to zirconium are present.

FIG. 3D shows X-ray diffraction spectra of RFC@Mn(1%)O and RFC@Mn(1%) synthesized according to Example 1 along with a comparative RFC. As illustrated, metal and metal oxide peaks corresponding to manganese are present.

### Example 3, Preparation of Cathode Active Materials

The synthesized RFC and various RFC@MO and RFC@M were used as hosts of active materials impregnated with sulfur. Each active material was prepared through a melt-diffusion approach. Typically, 1.1 g commercial element sulfur powders and 0.9 g host material (one of the synthesized RFC and various RFC@MO and RFC@M) were mixed and then ground by hand in an agate mortar for three minutes. The mixture then was transferred into a glass vessel and sealed. Then, the sealed vessel was placed in an oven and heated to a temperature of 155° C. and held at the target temperature for 12 hours. After cooling to room temperature, the sulfur infiltrated host material was obtained for use as the active material for electrode fabrication and further characterizations.

### Example 4, Characterizations of Cathode Active Materials

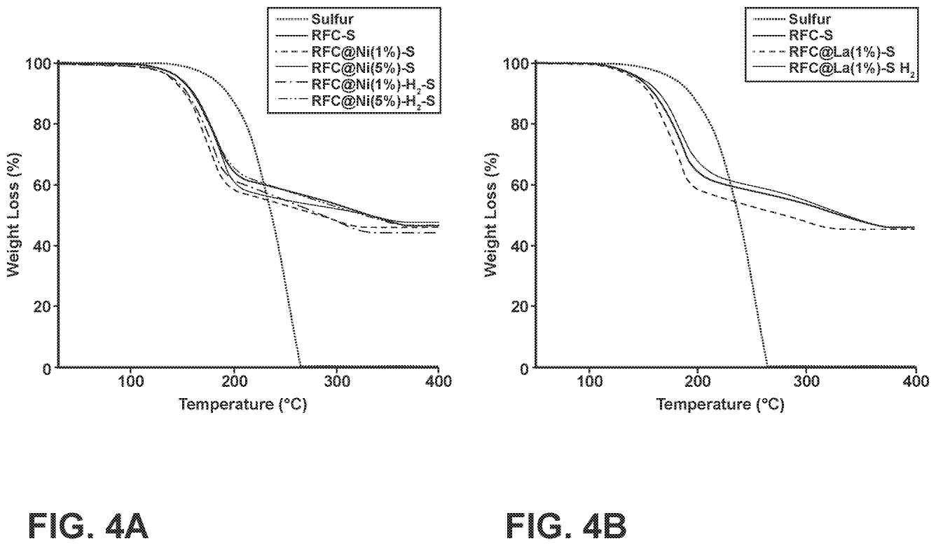

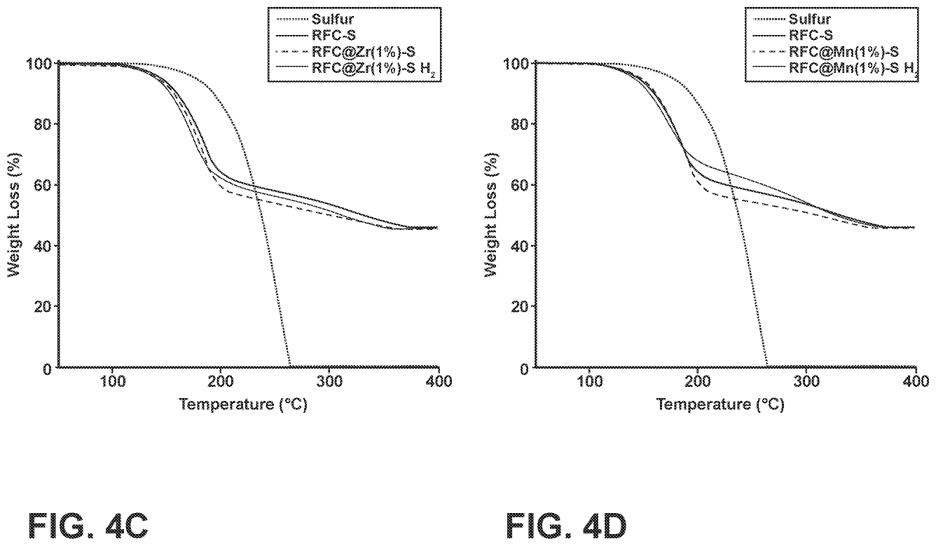

Referring to FIGS. 4A-4D, thermogravimetric analysis (TGA) was performed on a Thermogravimetric Analyzer (TGA Q500, TA Instruments) to determine the content of sulfur in the cathode active materials 20 synthesized according to Example 3. The TGA was conducted within a temperature range of 25-450° C. at a heating rate of 5° C./min under nitrogen atmosphere.

FIG. 4A shows TGA spectra of RFC@Ni(1%)O, RFC@Ni(1%), RFC@Ni(5%)O and RFC@Ni(5%) host materials synthesized according to Example 1, along with a comparative RFC, each impregnated with sulfur according to Example 3. A descending TGA thermal curve indicates that a weight loss occurred. In this way, FIG. 4A, demonstrates that elemental sulfur remained coupled to the synthesized host materials at temperatures of approximately 300° C. in a nitrogen atmosphere. This demonstrates that the host materials have a strong affinity to sulfur. In addition, host materials with metallic Ni demonstrate higher ending temperatures, compared with host materials with NiO. This indicates that host materials with metallic Ni may have a stronger affinity to sulfur. FIGS. 4B-4D show the same trend.

FIG. 4B shows TGA spectra of RFC@La(1%)O and RFC@La(1%) host materials synthesized according to Example 1, along with a comparative RFC, each impregnated with sulfur according to Example 3. As is demonstrated in FIG. 4B, elemental sulfur remained coupled to the host materials at temperatures of approximately 300° C. in a nitrogen atmosphere. This demonstrates that the synthesized host materials have a strong affinity to sulfur.

FIG. 4C shows TGA spectra of RFC@Zr(1%)O and RFC@Zr(1%) host materials synthesized according to Example 1, along with a comparative RFC, each impregnated with sulfur according to Example 3. As is demonstrated in FIG. 4C, elemental sulfur remained coupled to the host materials at temperatures of approximately 300° C. in a nitrogen atmosphere. This demonstrates that these synthesized host materials have a strong affinity to sulfur.

FIG. 4D shows TGA spectra of RFC@Mn(1%)O and RFC@Mn(1%) host materials synthesized according to Example 1, along with a comparative RFC, each impregnated with sulfur according to Example 3. As is demonstrated in FIG. 4D, elemental sulfur remained coupled to the host materials at temperatures of approximately 300° C. in a nitrogen atmosphere. This demonstrates that these synthesized host materials have a strong affinity to sulfur.

### Example 5. Preparation of Cathodes

The active materials were each mixed with carbon black (super C45) and binder solution containing polyvinylidene fluoride (PVDF, Solvay) dissolved in 1-Methyl-2-pyrrolidinone (NMP) to prepare a slurry. Typically, the slurry was mixed in a Thinky AR-100 mixer and then was hand-casted on aluminum foil. The resultant coating on the aluminum foil was then dried at 60° C. for 12 hours, under vacuum. The resulting dried electrodes were composed of 80% active material, 5% conductive carbon, and 15% binder and had a mass loading of around 1.4 mg-S/cm².

### Example 6, Preparation of Lithium-Sulfur Battery Cells

The dried electrode of Example 5 was punched into a disc having a 9/16 inch diameter and assembled into coin (CR2032) cells. Lithium metal was used as the counter electrode, and a polyolefin membrane (CELGARD® 2325) was used as the separator. A solution containing 1M lithium bis(trifluoromethane)sulfonimide (UTFSI) and 2 wt. % LiNO₃ dissolved in DOL/DME (1/1, v/v) was used as the electrolyte. The cells were assembled inside a glovebox filled with Argon.

### Example 7, Characterizations of Lithium-Sulfur Battery Cells

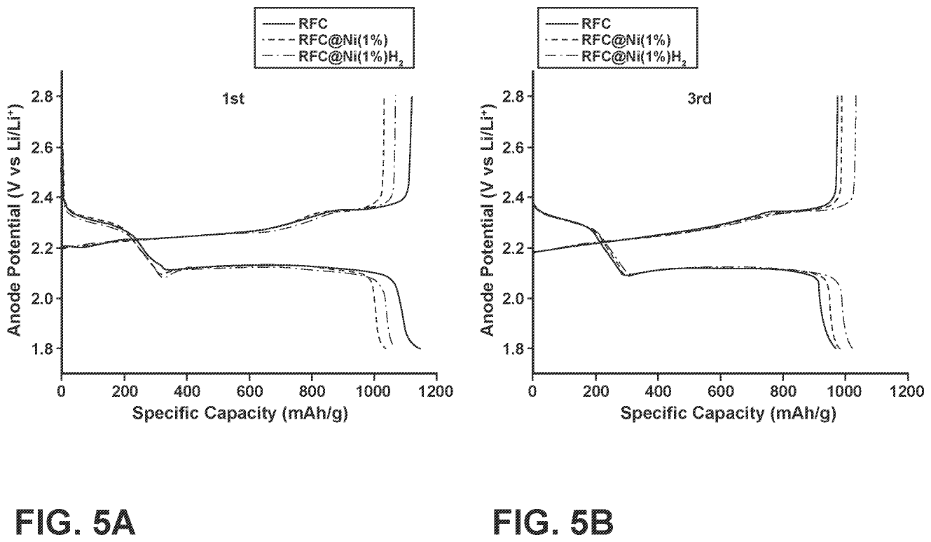

Referring now to FIGS. 5A-10B, galvanostatic cycling tests of the assembled cells of Example 6 were conducted on a NEWARE battery tester (BTS 4008) by applying a constant current at room temperature. Initially, three formation cycles with an approximate C/10 current were applied to obtain the exact capacity of the cells for following rate and cycling tests. After the formation cycles, the cycling test was conducted with a constant current density of 0.5 C applied for both charge and discharge processes. A voltage window of 1.8-2.8V was applied during both of the formation and cycling tests. As demonstrated by FIGS. 5A-9B, a lithium-sulfur battery cell 10 according to an aspect of the present disclosure may exhibit a charge and discharge specific capacity of approximately 900 mAh/g or greater during a galvanostatic cycling test under a constant current density of approximately 0.5 C and a voltage window of approximately 1.8-2.8 V for charge and discharge processes.

FIGS. 5A and 5B are graphs showing galvanostatic charge-discharge profiles for first and third formation cycles, respectively, of RFC@Ni(1%)O or RFC@Ni(1%) synthesized according to Example 1 along with a comparative RFC in lithium-sulfur battery cells assembled according to Examples 3 and 6. In these cycles, the prepared respective cathode having the synthesized RFC@Ni(1%)O, RFC@Ni(1%), or RFC host material included a sulfur loading of 1.3 mg/cm². The LSB cells exhibited charge and discharge specific capacities of approximately 1,000-1,200 mAh/g during the first cycles and specific capacities of approximately 900-1,050 mAh/g during the third cycles.

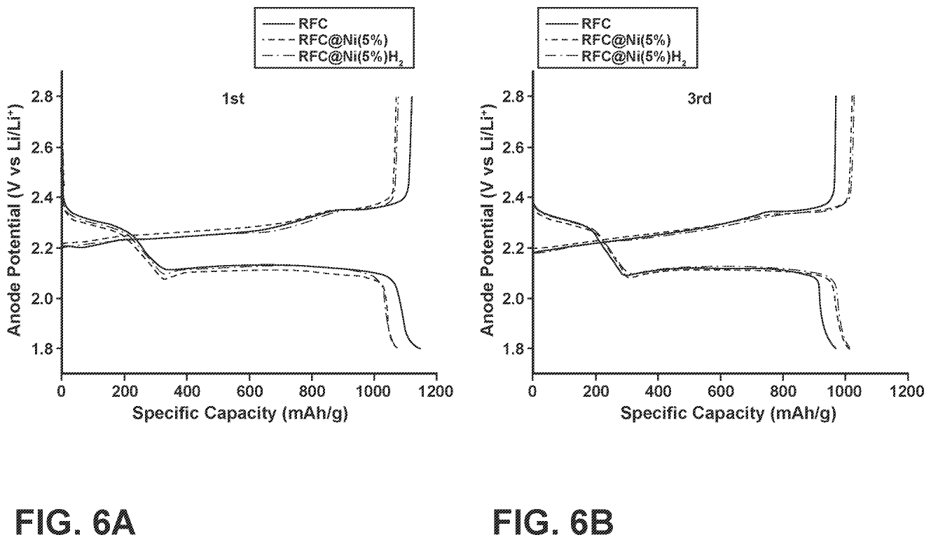

FIGS. 6A and 6B are graphs showing galvanostatic charge-discharge profiles for first and third formation cycles, respectively, of RFC@Ni(5%)O or RFC@Ni(5%) synthesized according to Example 1 along with a comparative RFC in lithium-sulfur battery cells assembled according to Examples 3 and 6. In these cycles, the prepared respective cathode having the synthesized RFC@Ni(5%)O, RFC@Ni(5%), or RFC host material included a sulfur loading of 1.6 mg/cm². The LSB cells exhibited charge and discharge specific capacities of approximately 1,100-1,200 mAh/g during the first cycles and specific capacities of approximately 900-1,050 mAh/g during the third cycles.

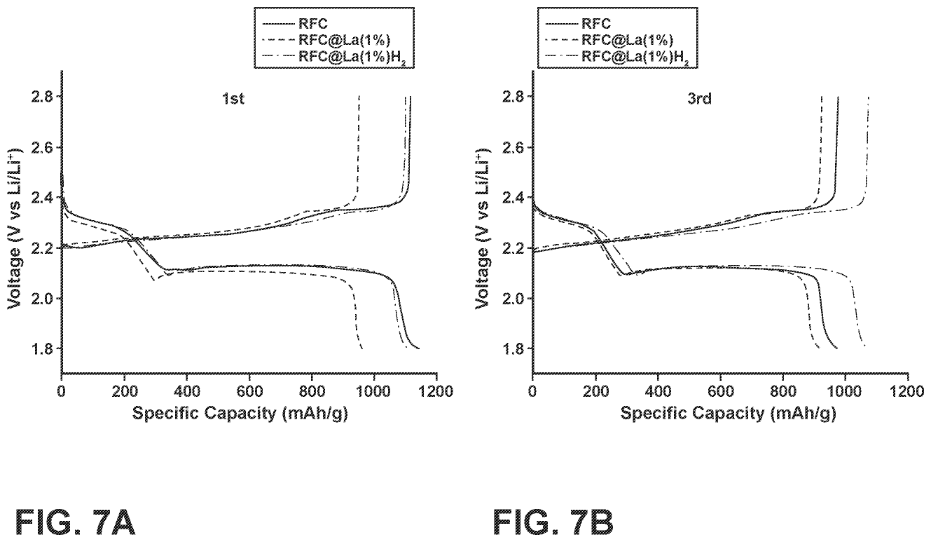

FIGS. 7A-7B are graphs showing galvanostatic charge-discharge profiles for first and third formation cycles, respectively, of RFC@La(1%)O or RFC@La(1%) synthesized according to Example 1 along with a comparative RFC in lithium-sulfur battery cells assembled according to Examples 3 and 6. In these cycles, the prepared respective cathode having the synthesized RFC@La(1%)O, RFC@La(1%), or RFC host material included a sulfur loading of 1.3 mg/cm². The LSB cells exhibited charge and discharge specific capacities of approximately 900-1,175 mAh/g during the first cycles and specific capacities of approximately 900-1,100 mAh/g during the third cycles.

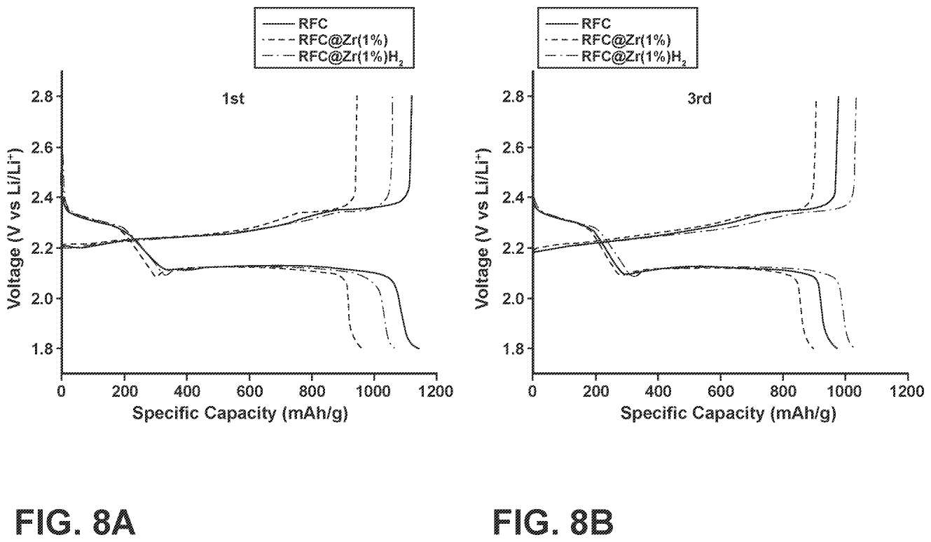

FIGS. 8A-8B are graphs showing galvanostatic charge-discharge profiles for first and third formation cycles, respectively, of RFC@Zr(1%)O or RFC@Zr(1%) synthesized according to Example 1 along with a comparative RFC in lithium-sulfur battery cells assembled according to Examples 3 and 6. In these cycles, the prepared respective cathode having the synthesized RFC@Zr(1%)O, RFC@Zr(1%), or RFC host material included a sulfur loading of 1.3 mg/cm². The LSB cells exhibited charge and discharge specific capacities of approximately 950-1,175 mAh/g during the first cycles and specific capacities of approximately 900-1,050 mAh/g during the third cycles.

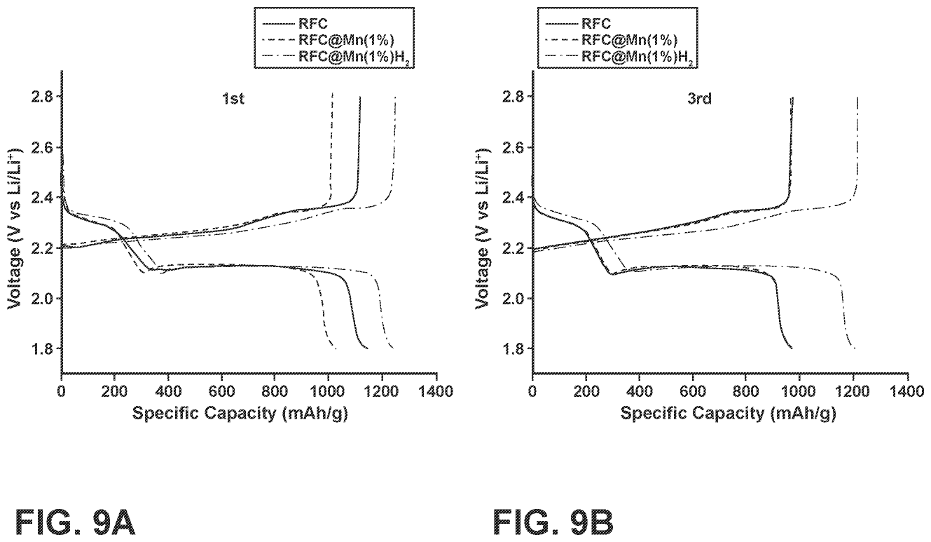

FIGS. 9A-9B are graphs showing galvanostatic charge-discharge profiles for first and third formation cycles, respectively, of RFC@Mn(1%)O or RFC@Mn(1%) synthesized according to Example 1 along with a comparative RFC in lithium-sulfur battery cells assembled according to Examples 3 and 6. In these cycles, the prepared respective cathode having the synthesized RFC@Mn(1%)O, RFC@Mn(1%), or RFC host material included a sulfur loading of 1.3 mg/cm². The LSB cells exhibited charge and discharge specific capacities of approximately 1,000-1,250 mAh/g during the first cycles and specific capacities of approximately 900-1,200 mAh/g during the third cycles.

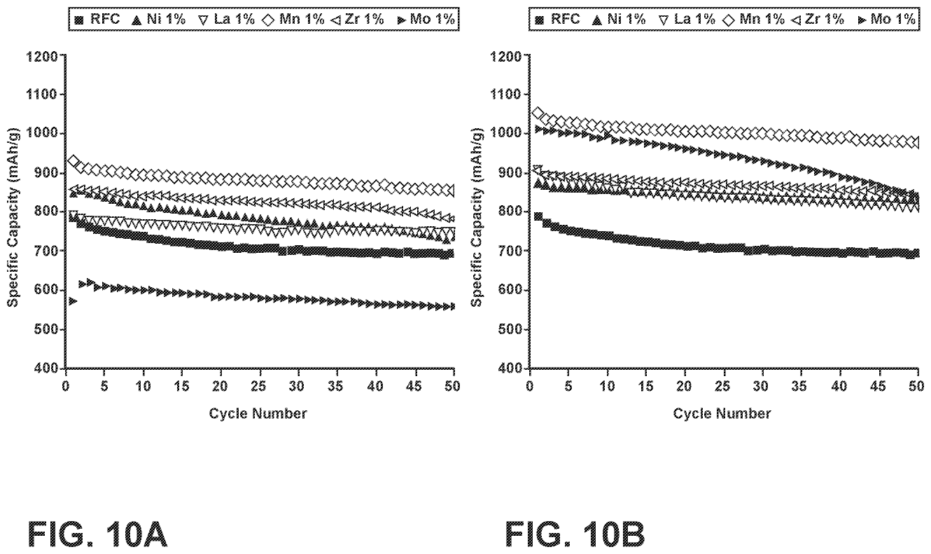

FIG. 10A is a graph showing a cycling performance graph of lithium-sulfur battery cells assembled according to Examples 3 and 6 with various carbon and metal oxide hosts. FIG. 10A demonstrates that the lithium-sulfur battery cells had negligible fading for all of the various carbon and metal oxide hosts for over 50 cycles, except molybdenum oxide (Mo). However, the capacity of reference cells with RFC drop from ˜800 mAh/g to ˜700 mAh/g after initial 50 cycles.

FIG. 10B is a graph showing a cycling performance graph of lithium-sulfur battery cells assembled according to Examples 3 and 6 with various carbon and metal hosts. FIG. 10B demonstrates that the lithium-sulfur battery cells had negligible fading for all of the various metal hosts for over 50 cycles, except Mo.

A benefit of the cathode 16 including the active material 20 including a carbon and metal, or metal oxide composite, according to various aspects disclosed herein include, but are not limited to, improved electrochemical performance of lithium-sulfur batteries (LSBs). Lithium-sulfur batteries 10 according to the present disclosure may provide increased cycling stability, which may be a result of the ability of the disclosed cathode 16 to retain polysulfides within a cathode region and to effectively transport ions (e.g., sulfur ions through pores). Aspects of the present disclosure may facilitate commercialization of LSBs due to the high energy density and a long life of the LSBs 10 described herein.

According to an aspect of the present disclosure, a lithium-sulfur battery cell may comprise an anode adjacent a first current collector, and the anode may comprise lithium metal. A cathode is coupled to a second current collector, and the cathode may comprise an active material. The active material may comprise a host, and the host may comprise resorcinol-formaldehyde carbon (RFC) and one (or both) of a metal and metal oxide. Elemental sulfur may be coupled to the host. The cathode may further comprise a conductive additive and a binder material. A separator may be operably disposed between the anode and the cathode, and an electrolyte may be dispersed between the anode and the cathode.

According to another aspect of the present disclosure, the lithium-sulfur battery cell may comprise a mass loading of the cathode on the second current collector in a range of approximately 1.04-9.0 mg-S/cm².

According to yet another aspect of the present disclosure, the one (or both) of the metal and metal oxide include any one or more of Ni, Mn, Fe, La, Zr, and Mo.

According to still another aspect of the present disclosure, the lithium-sulfur battery cell may comprise approximately 80 weight % of the cathode active material, approximately 5 weight % of the conductive additive, and approximately 15% of the binder material.

According to another aspect of the present disclosure, the elemental sulfur may remain coupled to the host at temperatures of approximately 300° C. in a nitrogen atmosphere, thereby demonstrating a strong affinity of the host to the sulfur.

According to yet another aspect of the present disclosure, the lithium-sulfur battery cell may exhibit a charge and discharge specific capacity of approximately 900-1200 mAh/g during a galvanostatic cycling test under a constant current density of approximately 0.5 C and a voltage window of approximately 1.8-2.8 V for charge and discharge processes.

According to still another aspect of the present disclosure, a cathode material for a lithium-sulfur battery cell may comprise an active material that includes a host. The host may include resorcinol-formaldehyde carbon (RFC) and one (or both) of a metal and metal oxide, and elemental sulfur may be coupled to the host. The cathode material may further comprise a conductive carbon material and a binder material.

According to another aspect of the present disclosure, the cathode material for the lithium-sulfur battery cell may include a mass loading of the cathode on a current collector in a range of approximately 1.0-9.04 mg-S/cm².

According to yet another aspect of the present disclosure, the one of the metal and metal oxide may include any one or more of Ni, Mn, Fe, La, Zr, and Mo.

According to still another aspect of the present disclosure, the cathode material for the lithium-sulfur battery cell may include a cathode which comprises approximately 80 weight % of the cathode active material, approximately 5 weight % of the conductive carbon material, and approximately 15 weight % of the binder material.

According to another aspect of the present disclosure, the cathode material for the lithium-sulfur battery cell may include elemental sulfur. The elemental sulfur may remain coupled to the host at temperatures of approximately 300° C. in a nitrogen atmosphere, thereby indicating a strong affinity of the host to the sulfur.

According to yet another aspect of the present disclosure, a method for preparing a cathode active material for a lithium-sulfur battery cell may comprise the steps of preparing a solution of a metal precursor and resorcinol-formaldehyde carbon (RFC). The method may also include performing a first thermal treatment on the solution of the metal precursor and RFC. A host material may then be obtained. The host material may comprise a powder composite RFC decorated with one or more metal oxides. The host material may then be impregnated with elemental sulfur to synthesize the cathode active material.

According to still another aspect of the present disclosure, the first thermal treatment may be conducted in a tube furnace or other suitable device under the protection of Argon gas or other suitable gas. A target temperature of approximately 500° C. is achieved with a ramp rate of approximately 10° C./min and the target temperature is held for approximately two (2) hours.

According to another aspect of the present disclosure, the metal precursor is at least one of NiSO₄, Mn(NO₃)₂, FeCl₃, La(NO₃)₃, Zr(NO₃)₄, and Mo(NO₃)₃.

According to yet another aspect of the present disclosure, the method for preparing a cathode active material for a lithium-sulfur battery cell may include performing a second thermal treatment on the RFC decorated with one or more metal oxides. The second thermal treatment may be conducted in a tube furnace or other suitable device under the protection of a mixture of approximately 98% Argon and 2% H₂ gas. A target temperature of approximately 900° C. may be achieved utilizing a ramp rate of approximately 10° C./min, and the target temperature may be held for approximately four (4) hours. The method may further include obtaining a host material that comprises a powder composite RFC decorated with one or more metals.

A cathode according to still another aspect of the present disclosure may comprise the cathode active material prepared by the method.

The cathode may further comprise approximately 80 weight % of the cathode active material, approximately 5 weight % of a conductive additive, and approximately 15 weight % of a binder material.

According to yet another aspect of the present disclosure, the cathode may have a mass loading of sulfur of approximately 1.4 mg/cm².

According to still another aspect of the present disclosure, a lithium-sulfur battery cell may comprise the cathode.

The lithium-sulfur battery cell may exhibit a charge and discharge specific capacity of approximately 900 mAh/g or greater during a galvanostatic cycling test under a constant current density of approximately 0.5 C and a voltage window of approximately 1.8-2.8 V for charge and discharge processes.

Additionally, unless otherwise specified, it is to be understood that discussion of a particular feature or component extending in or along a given direction, or the like, does not mean that the feature or component follows a straight line or axis in such a direction or that it only extends in such direction or on such a plane without other directional components or deviations, unless otherwise specified. It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A lithium-sulfur battery cell, comprising:
an anode coupled to a first current collector, the anode comprising lithium metal;
a cathode coupled to a second current collector, the cathode comprising:
an active material comprising:
a host including (1) resorcinol-formaldehyde carbon (RFC) having one or both of a metal and a metal oxide on a surface of the RFC; and (2) elemental sulfur coupled to the host; and
a conductive additive; and
a binder material;
a separator operably disposed between the anode and the cathode; and
an electrolyte dispersed between the anode and the cathode.

2. The lithium-sulfur battery cell of claim 1, wherein:
a mass loading of the cathode on the second current collector is in a range of approximately 1.0-9.04 mg-S/cm².

3. The lithium-sulfur battery cell of claim 1, wherein:
the one of the metal and metal oxide include any one or more of Ni, Mn, Fe, La, Zr, and Mo.

4. The lithium-sulfur battery cell of any one of claims 1-4, wherein:
the cathode comprises approximately 80 weight % of the cathode active material, approximately 5 weight % of the conductive additive, and approximately 15% of the binder material.

5. The lithium-sulfur battery cell of any one of claims 1-4, wherein:
the host has a strong affinity to the sulfur whereby the elemental sulfur remains coupled to the host at temperatures of approximately 300° C. in a nitrogen atmosphere.

6. The lithium-sulfur battery cell of any one of claims 1-4, wherein:
the lithium-sulfur battery cell exhibits a charge and discharge specific capacity of approximately 900-1200 mAh/g during galvanostatic cycling under a constant current density of approximately 0.5 C and a voltage window of approximately 1.8-2.8 V for a plurality of charge and discharge processes.

7. A cathode material for a lithium-sulfur battery cell, the cathode material comprising:
an active material including:
a host including (1) resorcinol-formaldehyde carbon (RFC) and one or both of a metal and a metal oxide; and (2) elemental sulfur coupled to the host; and
a conductive carbon material; and
a binder material.

8. The cathode material for the lithium-sulfur battery cell of claim 7, wherein:
a mass loading of the cathode on a current collector is in a range of approximately 1.4 mg-S/cm².

9. The cathode material for the lithium-sulfur battery cell of claim 7, wherein:
the one of the metal and metal oxide include any one or more of Ni, Mn, Fe, La, Zr, and Mo.

10. The cathode material for the lithium-sulfur battery cell of claim 7, wherein:
the cathode comprises approximately 80 weight % of the cathode active material, approximately 5 weight % of the conductive carbon material, and approximately 15 weight % of the binder material.

11. The cathode material for the lithium-sulfur battery cell of any one of claims 7-10, wherein:
the host has a strong affinity to the sulfur whereby the elemental sulfur remains coupled to the host at temperatures of 300° C. in a nitrogen atmosphere.

12. A method for preparing a cathode active material for a lithium-sulfur battery cell, comprising the steps of:
preparing a solution of a metal precursor and resorcinol-formaldehyde carbon (RFC);
performing a first thermal treatment on the solution of metal precursor and RFC;
obtaining a host material comprising a powder composite RFC decorated with one or more metal oxides; and
impregnating the host material with elemental sulfur to synthesize the cathode active material.

13. The method for preparing a cathode active material for a lithium-sulfur battery cell of claim 12, wherein the first thermal treatment is conducted in a tube furnace under the protection of Argon gas, further wherein a target temperature of approximately 500° C. is achieved with a ramp rate of approximately 10° C./min and the target temperature is held for approximately two hours.

14. The method for preparing a cathode active material for a lithium-sulfur battery cell of claim 12, wherein the metal precursor is at least one of NiSO₄, Mn(NO₃)₂, FeCl₃, La(NO₃)₃, Zr(NO₃)₄, and Mo(NO₃)₃.

15. The method for preparing a cathode active material for a lithium-sulfur battery cell of any of claims 12-14, further comprising:
performing a second thermal treatment on the RFC decorated with one or more metal oxides, wherein the second thermal treatment is conducted in a tube furnace under the protection of a mixture of approximately 98% Argon and 2% H₂ gas, further wherein a target temperature of approximately 900° C. is achieved with a ramp rate of approximately 10° C./min and the target temperature is held for approximately four hours; and
obtaining a host material comprising a powder composite RFC decorated with one or more metals.

16. A cathode comprising the cathode active material prepared by the method of any of claims 12-15.

17. The cathode of claim 16, further comprising approximately 80 weight % of the cathode active material, approximately 5 weight % of a conductive additive, and approximately 15 weight % of a binder material.

18. The cathode of either one of claims 16 or 17, having a mass loading of sulfur of approximately 1.4 mg/cm².

19. A lithium-sulfur battery cell comprising the cathode of any of claims 16-18.

20. The lithium-sulfur battery cell of claim 19, wherein the lithium-sulfur battery cell exhibits a charge and discharge specific capacity of approximately 900 mAh/g or greater during a galvanostatic cycling test under a constant current density of approximately 0.5 C and a voltage window of approximately 1.8-2.8 V for charge and discharge processes.

1-20. (canceled)

21. A lithium-sulfur battery cell, comprising:
a cathode coupled to a first current collector, the cathode comprising:
an active material comprising:
a host including (1) a porous carbon having one or both of a metal and a metal oxide on a surface; and (2) elemental sulfur coupled to the host; and
a conductive additive; and
a binder material.

22. The lithium-sulfur battery cell of claim 21, further comprising:
an anode coupled to a second current collector, the anode comprising lithium metal;
a separator operably disposed between the anode and the cathode; and
an electrolyte dispersed between the anode and the cathode.

23. The lithium-sulfur battery cell of claim 21, wherein
the porous carbon is resorcinol-formaldehyde carbon (RFC).

24. The lithium-sulfur battery cell of claim 21, wherein:
a mass loading of the cathode on the first current collector is in a range of approximately 1.0-9.04 mg-S/cm².

25. The lithium-sulfur battery cell of claim 21, wherein:
the one of the metal and metal oxide include any one or more of Ni, Mn, Fe, La, Zr, and Mo.

26. The lithium-sulfur battery cell of claim 21, wherein:
the cathode comprises approximately 80 weight % of the cathode active material, approximately 5 weight % of the conductive additive, and approximately 15% of the binder material.

27. The lithium-sulfur battery cell of claim 21, wherein:
the host has a strong affinity to the sulfur whereby the elemental sulfur remains coupled to the host at temperatures of approximately 300 C in a nitrogen atmosphere.

28. The lithium-sulfur battery cell of claim 21, wherein:
the lithium-sulfur battery cell exhibits a charge and discharge specific capacity of approximately 900-1200 mAh/g during galvanostatic cycling under a constant current density of approximately 0.5 C and a voltage window of approximately 1.8-2.8 V for a plurality of charge and discharge processes.

29. A cathode material for a battery cell, the cathode material comprising:
an active material including:
a host including (1) a porous carbon and one or both of a metal and a metal oxide; and
(2) elemental sulfur coupled to the host; and
a conductive carbon material; and
a binder material.

30. The cathode material of claim 29, wherein
the porous carbon is resorcinol-formaldehyde carbon (RFC).

31. The cathode material of claim 29, wherein:
the one of the metal and metal oxide include any one or more of Ni, Mn, Fe, La, Zr, and Mo.

32. The cathode material of claim 29, wherein:
the cathode material comprises approximately 80 weight % of the active material, approximately 5 weight % of the conductive carbon material, and approximately 15 weight % of the binder material.

33. The cathode material of claim 29, wherein:
the host has a strong affinity to the sulfur whereby the elemental sulfur remains coupled to the host at temperatures of 300 C in a nitrogen atmosphere.

34. A method for preparing an active material for a cathode, comprising the steps of:
preparing a solution of a metal precursor and a porous carbon;
performing a first thermal treatment on the solution of metal precursor and porous carbon;
obtaining a host material comprising a powder composite porous carbon decorated with one or more metal oxides; and
impregnating the host material with elemental sulfur to synthesize the active material.

35. The method for preparing an active material for a cathode of claim 34, wherein the first thermal treatment is conducted in a tube furnace under the protection of Argon gas, further wherein a target temperature of approximately 500 C is achieved with a ramp rate of approximately 10 C/min and the target temperature is held for approximately two hours.

36. The method for preparing an active material for a cathode of claim 34, further comprising:
performing a second thermal treatment on the porous carbon decorated with one or more metal oxides, wherein the second thermal treatment is conducted in a tube furnace under the protection of a mixture of approximately 98% Argon and 2% H₂ gas, further wherein a target temperature of approximately 900 C is achieved with a ramp rate of approximately 10 C/min and the target temperature is held for approximately four hours; and
obtaining a host material comprising a powder composite porous carbon decorated with one or more metals.

37. The method for preparing an active material for a cathode of claim 34, wherein the porous carbon is RFC.

38. The method for preparing an active material for a cathode of claim 34, wherein the metal precursor is at least one of NiSO₄, Mn(NO₃)₂, FeCl₃, La(NO₃)₃, Zr(NO₃)₄, and Mo(NO₃)₃.

39. The method for preparing an active material for a cathode of claim 34, wherein the sulfur has a mass loading of sulfur of approximately 1.4 mg/cm².

40. The lithium-sulfur battery cell of claim 21, wherein the lithium-sulfur battery cell exhibits a charge and discharge specific capacity of approximately 900 mAh/g or greater during a galvanostatic cycling test under a constant current density of approximately 0.5 C and a voltage window of approximately 1.8-2.8 V for charge and discharge processes.
